(19) United States
(12) Patent Application Publication
(10) Pub. No.: US 2013/0004600 A1
(43) Pub. Date: Jan. 3, 2013

(54) Animal repellent composition

(76) Inventor: Theodore Davidson, Saint-Basile (CA)

(21) Appl. No.: 13/135,291

(22) Filed: Jun. 30, 2011

(51) Int. Cl. A01N 65/08; A01N 65/22; A01P 17/00; A01N 65/38

(52) U.S. Cl. 424/734

(57) ABSTRACT

A liquid animal repellent composition having a liquid phase and an oil phase, the composition having oleoresins of capsicum, black pepper and rosemary along with surfactants and preservatives. A pH adjuster is also utilized.

### FIELD OF THE INVENTION

The present invention relates to animal repellent compositions and to a method of repelling animals at a desired location.

### BACKGROUND OF THE INVENTION

Compositions of matter used for repelling animals are well known in the art and there are various commercial compositions. The nature of the repellent composition will vary depending on the species of animal, bird or insect which it is intended to repel. Most of the repellents which have been utilized in the past are based on man made chemicals specifically targeted for certain species of animal. While these compositions are very effective, they are not considered ecologically desirable. Increasingly, regulatory authorities are banning or severely restricting the use of certain chemicals. These chemicals have been found to enter into the food and/or water supply and pose a health risk to humans.

The use of repellents containing naturally occurring ingredients is considered to be more environmentally friendly. Such repellents are shown, for example, in U.S. Pat. No. 4,455,304 which teaches the use of a composition for repelling birds. The composition includes a finely divided garlic constituent and a finely divided cayenne pepper constituent.

U.S. Pat. No. 4,795,637 teaches the use of a rodent repellent powder which uses thujone oil with a powder that can be selected from a number of different products including tobacco dust, pepper powder, sulfur powder, etc. The thujone oil is derived from the cedar tree and is a natural repellent.

U.S. Pat. No. 6,159,474 having common inventorship with the instant application teaches an animal repellent which contains oils of black pepper and/or capsicum. The composition utilizes a carrier along with an essential oil, an oleoresin, and an antioxidant to stabilize the oleoresin and the essential oil. This composition has been found to be effective and can be utilized as a repellent for a number of different larger species of animals such as dogs, cats, racoons, skunks, mice, rats, squirrels, chipmunks, deer, etc. The composition utilizes only naturally occurring compounds for ecological reasons.

### SUMMARY OF THE INVENTION

It is an object of the present invention to provide an improved repellent composition which is effective against animals, utilizes naturally occurring ingredients and which has a minimum of toxicity.

It is a further object of the present invention to provide a method for natural repelling of domestic and other animals which have an olfactory capability.

According to one aspect of the present invention there is provided a liquid animal repellent composition comprising a liquid phase and an oil phase, the liquid phase and the oil phase being mixed together, the oil phase comprising an oleoresin of capsicum in an amount of between 2% and 6% by weight, an oleoresin of black pepper in an amount of between 2% and 6% by weight, an oleoresin of rosemary in an amount of between 0.1% and 0.4% by weight, a non ionic surfactant in an amount of between 25% and 45% by weight, diacetyl tartaric acid esters of monoglycerides in an amount of between 25% to 45% by weight, the liquid phase comprising between 10% and 20% by weight, the liquid phase comprising water, a preservative, a surfactant and a pH adjuster.

In greater detail, the repellent of the present invention is adapted to be used for a wide variety of animal species. It can be utilized for both domestic and wild animals which have olfactory capabilities. This would include dogs, cats, deers, skunks, racoons, groundhogs, gophers, etc.

The composition utilizes an oil phase in conjunction with a water phase. The two phases are then blended together to provide the final product.

In the oil phase, there is provided an oleoresin of both capsicum and black pepper. The active ingredient in the capsicum is capsacin, while the active ingredient of the black pepper oleoresin is piperine.

In addition to the oleoresins, there is also provided monodiglycerides along with an oleoresin of rosemary. Rosemary is an evergreen shrub of the mint family labiatae and is classified as genus rosemarinus species rosemarinus officinalis. The plant is widely used as a herb and is also used in perfumes. The oleoresin is desirable to provide a longer lasting effect to the repelling composition. Thus, it can function as an antioxidant to stabilize the other oleoresins. For example, the oleoresin of capsicum will normally oxidize within 48 hours if it is not stabilized.

The percentage of the oleoresin of rosemary must be controlled since it must be used in an amount sufficient to perform its function as an antioxidant while too large a quantity will tend to neutralize the active repellent components. Preferably, the oleoresin of rosemary will be present in an amount of between 0.10 and 0.30 by weight.

The oleoresins of capsicum and black pepper are preferably present in approximately equal quantities and which may range from 1% to 7% by weight of the composition.

The three oleoresins are mixed and heated and monodiglycerides added thereto. The monodiglycerides are typically added in an amount of between 1% and 4% by weight of the final composition.

Subsequently, polysorbate 80K is added to the mixture and the mixture allowed to cool. The polysorbate preferably is present in an amount of between 25 to 40% by weight of the final composition.

Finally, for the oil phase, a bonsai extender which is a mixture of black pepper oils and diacetyl tartaric acid esters of monoglycerides are added. The bonzai extender is preferably added in an amount of between 2% and 6% by weight of the final composition while the diacetyl tartaric acid is present in an amount of between 25 to 45% by weight of the final composition.

The water phase will comprise biodegradable surfactants and enzymes along with sodium benzoate and potassium sorbate. Citric acid may also be employed, all of the above ingredients being present in relatively minor amounts, each below 1% by weight. They are mixed with water which will be present in an amount of between 10 to 20% by weight of the final composition. Once the water phase is mixed, it is then blended with the oil phase to form the final composition.

### EXAMPLE 1

A composition was prepared according to the following formula:

| | Percentage |
|---|---|
| | by weight |
| Oleoresin of capsicum | 4.6 |
| Oleoresin of black pepper | 4.3 |
| Mono-diglycerides | 2.2 |
| Oleoresin of rosemary | 0.2 |
| Polysorbate 80K | 33.05 |
| Bonzai extender | 4.0 |
| Diacetyl tartaric acid esters | 37.05 |
| of mono-glycerides | |
| Water | 13.00 |
| Citric acid | 0.5 |
| Biodegradable surfactants | 0.5 |
| and enzymes | |
| Sodium benzoate | 0.3 |
| Potassium sorbate | 0.3 |
| Total: | 100.00 |

The oleoresin of capsicum, oleoresin of black pepper, the mono-diglycerides and the oleoresin of rosemary were mixed well and heated until dissolved.

Subsequently, the polysorbate 80K was mixed in and the composition allowed to cool. The bonzai extender, diacetyl tartaric acid esters of mono-glycerides were subsequently mixed into the composition.

In a separate container, the water, citric acid, biodegradable surfactants and enzymes, sodium benzoate and potassium sorbate were mixed.

The oil phase was then blended with the water phase.

The composition was applied by spraying to a field having problems with skunks and groundhogs and it was found to be effective for a period of approximately 30 days.

It will be understood that the above described embodiments are for purposes of illustration only and that changes and modifications may be made thereto without departing from the spirit and scope of the invention.

I claim:

1. A liquid animal repellent composition comprising:
a liquid phase and an oil phase, said liquid phase and said oil phase being mixed together, said oil phase comprising:
an oleoresin of capsicum in an amount of between 2% and 6% by weight;
an oleoresin of black pepper in an amount of between 2% and 6% by weight;
an oleoresin of rosemary in an amount of between 0.1% and 0.4% by weight;
a non ionic surfactant in an amount of between 25% and 45% by weight;
diacetyl tartaric acid esters of monoglycerides in an amount of between 25% to 45% by weight;
said liquid phase comprising between 10% and 20% by weight, said liquid phase comprising water, a preservative, a surfactant and a pH adjuster.

2. The composition of claim 1 wherein said oleoresin of capsicum is present in an amount of between 4% and 5% by weight.

3. The composition of claim 1 wherein said oleoresin of black pepper is present in an amount of between 4% and 5% by weight.

4. The composition of claim 1 wherein said oleoresin of rosemary is present in an amount of between 0.15% and 0.25% by weight.

5. The composition of claim 1 wherein said non ionic surfactant is present in an amount of between 30% and 35% by weight.

6. The composition of claim 1 wherein said diacetyl tartaric acid esters of monoglycerides is present in an amount of between 30% to 40% by weight.

7. The composition of claim 1 wherein said liquid phase is present in an amount of between 12% and 16% by weight.

8. The composition of claim 1 further including an emulsifier added to said oleoresins, said emulsifier being present in an amount of between 1% and 3% by weight.

9. The composition of claim 1 further including a blend of black pepper oils, said black pepper oils being present in an amount of between 2% and 6% by weight.

10. A method for the preparation of the liquid animal repellent composition of claim 1 comprising the steps of:
mixing together said oleoresins, heating said oleoresins until dissolved, adding said non ionic surfactant and mixing the composition, cooling the composition, adding said diacetyl tartaric acid esters of monoglycerides and further mixing the composition;
mixing together said liquid phase, and subsequently blending said oil phase with said water phase.
